(19) United States
(12) Patent Application Publication
(10) Pub. No.: US 2006/0160548 A1
(43) Pub. Date: Jul. 20, 2006

(54) Method and system for information feedback based on instant messaging communication

(75) Inventors: Yu Chen, Shenzhen (CN); Weiguang Huang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Tencent Technology (Shenzhen) Company Ltd., Shenzhen (CN)

(21) Appl. No.: 11/317,581

(22) Filed: Dec. 23, 2005

Related U.S. Application Data
(63) Continuation of application No. PCT/CN04/01035, filed on Sep. 9, 2004.

(30) Foreign Application Priority Data
Sep. 12, 2003 (CN) 03146801.2

(51) Int. Cl. H04Q 7/20

(52) U.S. Cl. 455/466

(57) ABSTRACT

Disclosed herein is an information feedback method and system based on instant messaging relating to telecommunication techniques. An instant messaging system obtains a location of a mobile terminal from a mobile positioning system according to request information of the mobile terminal. An automatic information processing system generates location-based information according to the content of the request information and obtained location. The instant messaging system feeds back the location-based information to the mobile terminal. The request information that the mobile terminal sends to the instant messaging system includes an instant messaging identifier of the mobile terminal. The instant messaging system obtains a corresponding and relevant mobile identifier according to the instant messaging identifier. The mobile identifier indicates the information identifier of the mobile terminal in the mobile network system and is used for the mobile positioning system to obtain the location of the mobile terminal. In this way, the disclosed method and system provide a value-added technique relating to location with high serviceability and practicability.

### CROSS-REFERENCES TO RELATED APPLICATIONS

This is a continuation of International Application No. PCT/CN2004/001035, which was filed on Sep. 9, 2004, and which, in turn, claimed the benefit of Chinese Patent Application No. 03146801.2, which was filed on Sep. 12, 2003, the entire disclosures of which are hereby incorporated herein by reference.

### BACKGROUND OF THE DISCLOSURE

1. Field of the Technology

The present invention relates to telecommunication techniques and, more particularly, to an information feedback method and system based on instant messaging.

2. Background of the Invention

At present, in the mobile communication technique field, positioning services are widely adopted. These services are implemented by a special mobile positioning system that interacts with the mobile terminal, so as to obtain the location of this mobile terminal and provide relevant location-based information for itself.

In the meantime, in the network communication techniques field, Instant Messaging (IM) services are being widely adopted. These services are communication services based on the Internet. The instant messaging function on the Internet can be implemented by adopting this communication service. The instant messaging service thereof can provide various functions by adopting an instant messaging tool, where the subscriber can perform operations like text chatting, file transferring, sending short messages to cell phones and so on. This instant messaging service and instant messaging tool thereof are recognized and widely adopted on the Internet due to advantages of speed, multiple functions, stable performance, ease of use, etc. Other developments are proceeding in the direction of integration with the network virtual community.

With the popularization of network communications and the mobile telephone, value-added services integrating network functionality with mobile communication functionality emerge. To increase service quality and expand custom quantity, Internet Service Providers (ISP) and Internet Content Providers (ICP) have both placed a priority on increasing the above-noted value-added service quality. This value-added service has become a main trend of development for both ISPs and ICPs.

If positioning service in mobile communication and instant messaging service in network communication can be integrated, a value-added service with enormous market potential can be provided.

In existing techniques, there is an automatic information feedback technique in mobile communications, which identifies the instant messaging tool as an application for querying the input client end so that the instant messaging tool and mobile communication are integrated. However, positioning service and instant messaging service are not integrated in this technique, such that the value-added service integrating positioning service and instant messaging service cannot be implemented. In existing techniques, there are other methods to implementing service, which can only provide location-based information of this subscriber for this subscriber and cannot integrate positioning service with instant messaging service. Consequently, the value-added service integrating positioning service and instant messaging service cannot be implemented.

### SUMMARY OF THE INVENTION

In accordance with certain aspects of the disclosure, an information feedback method and system based on instant messaging are provided, which implement a value-added service integrating positioning service and instant messaging service.

In accordance with one aspect of the disclosure, an information feedback method includes the following steps:

(A) according to the instant messaging identifier that is included in the request information sent by mobile terminal, determining a location of this mobile terminal; and,

(B) according to the location determined in step (A) and contents of the request information, generating relevant location-based information, and feeding back the generated information to the mobile terminal.

In some cases, step (A) includes the following steps:

(A1) the mobile terminal sending a request with at least corresponding instant messaging identifier of this mobile terminal to an instant messaging system;

(A2) according to the instant messaging identifier in the request information, the instant messaging system determining the corresponding mobile identifier of this instant messaging identifier, and sending this mobile identifier to a mobile positioning system; and,

(A3) the mobile positioning system determining the location of the mobile terminal according to the received mobile identifier.

In some embodiments, step (A2) includes the following steps:

(A21) a real-time interaction query module of the instant messaging system sending a query request to a data module that stores corresponding relations between instant messaging identifiers and mobile identifiers, where the query request including the mobile identifier;

(A22) according to the instant messaging identifier included in the query request, the data module querying the corresponding mobile identifier of this instant messaging identifier and returning the obtained mobile identifier and query result to the real-time interaction query module; and,

(A23) the real-time interaction query module sending the mobile identifier to the mobile positioning system.

In some cases, step (B) includes the following steps:

(B1) the instant messaging system transmitting contents of the request information and location of the mobile terminal to an automatic information processing system;

(B2) according to the contents of the request information and location, the automatic information processing system generating location-based information of the mobile terminal and returning this generated information to the instant messaging system; and,

(B3) the instant messaging system transmitting the location-based information of the mobile terminal to the mobile terminal through a mobile network system.

In some embodiments, step (B2) includes the following steps:

(B21) a message processing module of the automatic information processing system classifies contents of the request information, and if being an automatic reply type, executing step (B22), and if being a data extract type, executing step (B23);

(B22) an automatic reply module extracting corresponding data according to contents of the request information and generating reply content by integrating the data thereof with the location, and then returning the reply content that is taken as location-based information to the instant messaging system; and,

(B23) according to contents of the request information, a data extract module extracting corresponding information data from corresponding data storage position and generating reply content by integrating this information data with the location, and then returning this reply content that is taken as the location-based information to the instant messaging system.

Step (A1) may include the mobile terminal interacting with the instant messaging system that stores content of the request information to obtain and select content of the request information, and then transmitting content of the request information and the instant messaging identifier to the instant messaging system through the request information.

Alternatively or additionally, step (A1) may include the mobile terminal determining content of the request information according to the relevant content of the request information stored in itself, and transmitting the content of the request information and the instant messaging identifier to the instant messaging system through the request information. The disclosed method may then further include the mobile terminal updating relevant content of the request information stored in this mobile terminal by interacting with instant messaging system.

In accordance with another aspect of the disclosure, an information feedback system based on instant messaging is provided, the system including a mobile terminal, a mobile network system and a mobile positioning system. The mobile positioning system interacts with the mobile terminal through the mobile network system and determines a location of this mobile terminal according to the mobile identifier of this mobile terminal. The system further includes an instant messaging system, which is used for receiving request information transmitted by the mobile terminal through the mobile network system, determining the corresponding mobile identifier according to the instant messaging identifier in this request information, obtaining the location of the mobile terminal from the mobile positioning system with the mobile identifier, and then transmitting the location to an automatic information processing system of the system. The automatic information processing system is used for generating location-based information related with the mobile terminal according to the location and the content of the request information obtained from instant messaging system, and then feeding back the information to the mobile terminal through the instant messaging system and the mobile network system.

In some cases, the instant messaging system includes a real-time interaction query module and a data module. The real-time interaction query module may be used for receiving the request information sent by the mobile terminal, obtaining the mobile identifier by querying the data module according to the instant messaging identifier in this request information, obtaining the location of the mobile terminal from the mobile positioning system by using this mobile identifier, obtaining relevant location-based information from the automatic information processing system by using this location and content of the request information, and then transmitting this information to the mobile terminal. The data module may be used for storing corresponding relations between instant messaging identifiers and mobile identifiers.

In some embodiments, the real-time interaction query module includes a request information processing sub-module, a processing system interface sub-module and an identifier information query sub-module. The request information processing sub-module may be used for fulfilling an information interconnection with a positioning system interface sub-module. The positioning system interface sub-module may be used for providing communication between the request information processing sub-module and the mobile positioning system. The processing system interface sub-module may be used for providing communication between the request information processing sub-module and the automatic information processing system. The identifier information query sub-module may be used for obtaining request information from the request information processing sub-module, according to the instant messaging identifier included in this request information, sending a query request to data module for querying mobile identifier, and transmitting the obtained query result from the data module and the obtained mobile identifier to the request information processing sub-module.

In some cases, the real-time interaction query module further includes an information content data sub-module, which may be used for storing relevant content of request information and related menu item command and catalogue, and providing the content of request information for mobile terminal by interacting with the mobile terminal.

In accordance with certain aspects of the disclosure, an instant messaging system obtains a location of a mobile terminal from a mobile positioning system according to request information of the mobile terminal. An automatic information processing system generates location-based information according to the content of the request information and the obtained location, and the instant messaging system feeds back the location-based information to the mobile terminal. In this way, the mobile terminal obtains location-based information of itself through the instant messaging system. Therefore, the instant messaging system, the automatic information feedback technique and the positioning technique based on the location information are perfectly integrated, and a value-added service method relevant to location, and a system thereof, are provided.

The request information that the mobile terminal sends to the instant messaging system may include an instant messaging identifier of this mobile terminal. Then a corresponding and relevant mobile identifier is queried and obtained through the instant messaging system, such that features of the instant messaging service are fully utilized. In practical operation, a verification function is provided. In other words, if the corresponding and relevant mobile identifier is not obtained by querying the data module, the disclosed system can make the request invalid to further increase serviceability and practicability of the disclosed method and system. In short, the disclosure provides a value-added service method and system relevant to location and having strong serviceability and practicability.

### BRIEF DESCRIPTION OF THE DRAWINGS

FIG. 1 is a schematic diagram illustrating system principles in accordance with one embodiment of the disclosure.

FIG. 2 is a schematic diagram illustrating an internal structure of an instant messaging system in accordance with one embodiment of the disclosure.

### DETAILED DESCRIPTION OF PREFERRED EMBODIMENTS

The disclosed method and system will be described in detail hereinafter with reference to the accompanying drawings, where like reference numerals identify like elements throughout the drawings.

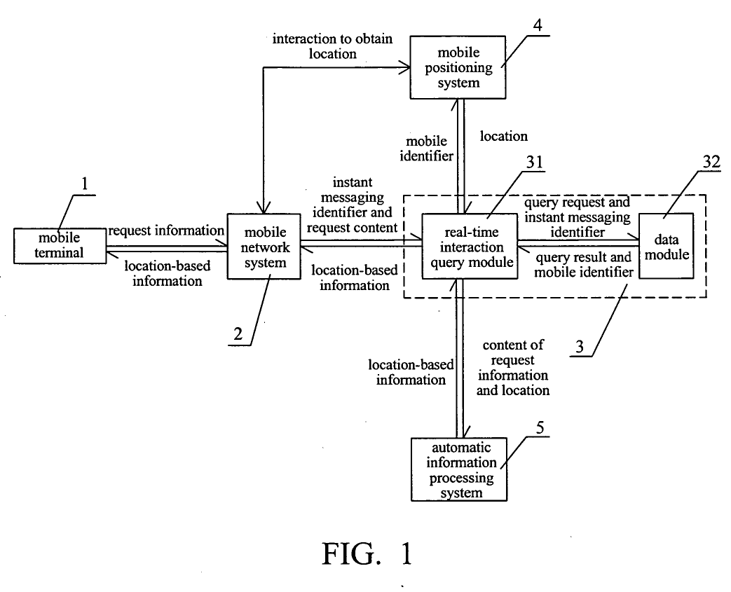

With reference to FIG. 1, the information feedback system based on instant messaging includes a mobile terminal 1, a mobile network system 2, an instant messaging system 3, a mobile positioning system 4, and an automatic information processing system 5.

The mobile terminal 1 is used to send request information, where the request information at least includes a corresponding instant messaging identifier of this mobile terminal 1 and service content of a current request. The mobile terminal 1 is also used to receive and display the finally obtained location-based information of this mobile terminal 1, and this information is corresponding to request service content included in the request information.

The mobile network system 2 is used to implement information interaction between the mobile terminal 1 and the instant messaging system 3, and is also used to implement information interaction between the mobile terminal 1 and the mobile positioning system 4.

The instant messaging system 3 is used to receive the request information sent by the mobile terminal 1, obtain the mobile identifier of this mobile terminal 1 according to the instant messaging identifier in this request information, send the obtained mobile identifier to the mobile positioning system 4, and after obtaining location-based information of this mobile terminal 1 from the mobile positioning system 4, transmit this location and related information data to the automatic information processing system 5.

The mobile positioning system 4 is used to obtain the location of this mobile terminal 1 according to the mobile identifier of the mobile terminal 1 obtained from the instant messaging system 3 and through interaction with the mobile terminal 1, and then transmit this location to the instant messaging system 3.

The automatic information processing system 5 is used to generate location-based information of the mobile terminal 1 according to the received location and related information data, and feed back this information from the instant messaging system 3 to the mobile terminal 1 by way of the mobile network system 2.

As shown in FIG. 1, the instant messaging system 3 includes a real-time interaction query module 31 and a data module 32, where the data module 32 includes an associative data list between instant messaging identifiers and corresponding mobile identifiers. The real-time interaction query module 31 performs corresponding query in the data module 32 and fulfills related external information intercommunication.

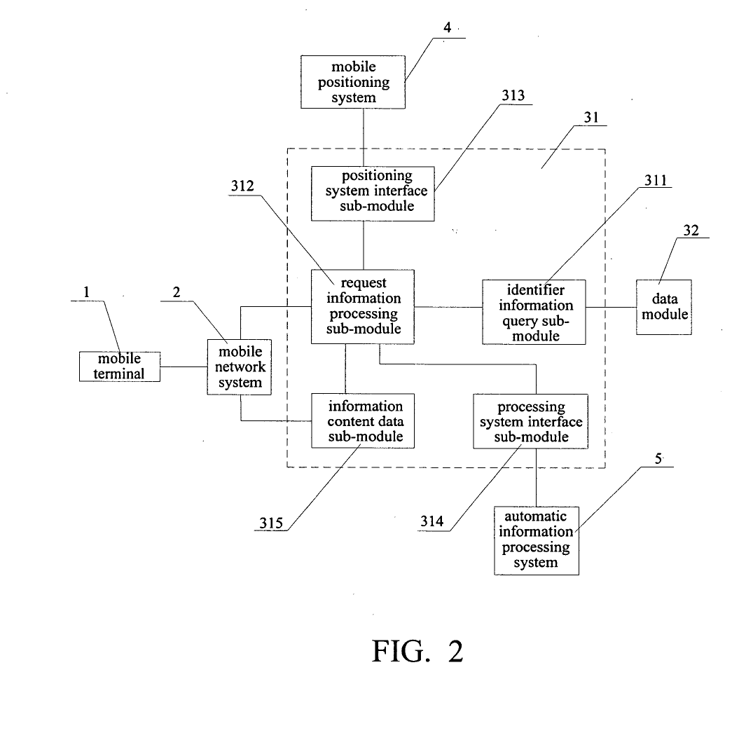

As shown in FIG. 2, the real-time interaction query module 31 includes an identifier information query sub-module 311, a request information processing sub-module 312, a positioning system interface sub-module 313, a processing system interface sub-module 314 and an information content data sub-module 315.

The request information processing sub-module 312 is used to receive, store and process related request information data, and receive and forward internal data and information of the real-time interaction query module 31, namely fulfill information interconnection with the positioning system interface sub-module 313, the processing system interface sub-module 314, the identifier information query sub-module 311 and the information content data sub-module 315.

The identifier information query sub-module 311 is used to obtain the request information from the request information processing sub-module 312, and according to the instant messaging identifier included in this request information, transmit a query request to the data module 32 for querying the mobile identifier, and after obtaining the mobile identifier from the data module 32, transmit this mobile identifier to the positioning system interface sub-module 313.

The positioning system interface sub-module 313 is used to provide a communication interface between the instant messaging system 3 and the mobile positioning system 4. The request information processing sub-module 312 transmits the mobile identifier obtained from the identifier information query sub-module 311 to the mobile positioning system 4 through this positioning system interface sub-module 313. After determining location of the mobile terminal 1 according to this mobile identifier, the mobile positioning system 4 transmits this location to the request information processing sub-module 312 through this positioning system interface sub-module 313.

The processing system interface sub-module 314 is used to provide a communication interface between the instant messaging system 3 and the automatic information processing system 5. On the one hand, the request information processing sub-module 312 transmits the obtained location and related information data to the automatic information processing system 5 through this processing system interface sub-module 314. On the other hand, through this processing system interface sub-module 314, the automatic information processing system 5 transmits the location-based information generated by itself to the request information processing sub-module 312, and finally transmits this information to the mobile terminal 1 through the request information processing sub-module 312.

The information content data sub-module 315 is used to store related content of the request information and relevant menu item command and catalog, and provide content of the request information relevant with location to the mobile terminal 1 by interacting with the mobile terminal 1.

In one embodiment, as shown in FIG. 1, the mobile terminal 1 stores relevant content of the request information. In other embodiments, the mobile terminal 1 can update the stored relevant content of the request information by interacting with the information content data sub-module 315 in the instant messaging system 3.

The disclosed information feedback method based on instant messaging will be described in detail hereinafter.

With reference to FIG. 1, the following steps implement the disclosed method. In a step (A), the mobile terminal 1 transmits the request information to the instant messaging system 3 through the mobile network system 2, where the transmitted the request information includes the instant messaging identifier of the mobile terminal 1 and related content of the request information.

With reference to FIG. 2, when the above-noted mobile terminal 1 is transmitting the request information to the instant messaging system 3, the mobile terminal 1 can obtain related menu item command, catalog, content of the request information, etc. by interacting with the information content data sub-module 315 in the instant messaging system 3 in the first place, and after selecting content of the request information, transmit instant messaging identifier and related content of the request information to the instant messaging system 3 through the request information. In one embodiment, the mobile terminal 1 stores relevant content of the request information and can determine content of the request information directly according to the stored content, and then transmit the instant messaging identifier and this content of the request information to the instant messaging system 3 through the request information without affecting implementation of the presentation. In addition, in condition of the mobile terminal 1 storing relevant content of the request information, this mobile terminal 1 can also update the content of the request information stored in the mobile terminal 1 by interacting with the instant messaging system 3.

In a step (B), after receiving the above-noted request information, the real-time interaction query module 31 in the instant messaging system 3 sends a query request to the data module 32, where the request includes instant messaging identifier carried by the request information. After receiving this query request, the data module 32 obtains the corresponding mobile identifier according to the instant messaging identifier in this request, and then returns the query result and obtained mobile identifier to the real-time interaction query module 31.

In step (B), if a corresponding and relevant mobile identifier is not obtained from the data module 32, the disclosed system can make the request invalid, and can indicate that it is unable to find a corresponding mobile identifier by way of the query result that the data module 32 has transmitted to the real-time interaction query module 31.

In step (B), after receiving the request information, the real-time interaction query module 31 in the instant messaging system 3 can also store request content and instant messaging identifier in the request information to be used in subsequent steps.

In a step (C), the real-time interaction query module 31 in the instant messaging system 3 transmits the obtained mobile identifier to the mobile positioning system 4. The mobile positioning system 4 determines location of the mobile terminal 1 according to this mobile identifier and by interacting with the mobile terminal 1, and then returns this location to the real-time interaction query module 31.

In a step (D), the real-time interaction query module 31 in the instant messaging system 3 transmits the content of the request information and the obtained location of the mobile terminal 1 to the automatic information processing system 5. The automatic information processing system 5 generates location-based information according to the content of the request information and obtained location, and then transmits the generated information to the real-time interaction query module 31 in the instant messaging system 3. Then the real-time interaction query module 31 in the instant messaging system 3 transmits this location-based information to the mobile terminal 1 through the mobile network system 2.

With reference to FIG. 2, specifics of steps (B), (C) and (D) will be introduced in detail hereinafter.

Step (B) is implemented through the following steps. In a step (B1), the request information processing sub-module 312 in the real-time interaction query module 31 receives the request information, and then transmits the request information to the identifier information query sub-module 311 in the real-time interaction query module 31. In a step (B2), the identifier information query sub-module 311 in the real-time interaction query module 31 sends a query request to the data module 32, where the query request includes the instant messaging identifier. The data module 32 queries according to this instant messaging identifier, and then returns the query result as well as corresponding and relevant mobile identifier to the identifier information query sub-module 311 in the real-time interaction query module 31. This mobile identifier indicates the information identifier of the mobile terminal 1 in the mobile network system 2. In a step (B3), the identifier information query sub-module 311 in the real-time interaction query module 31 transmits the returned query result as well as corresponding and relevant mobile identifier to the request information processing sub-module 312 in the real-time interaction query module 31.

Step (C) is implemented through the following steps. In a step (C1), the request information processing sub-module 312 in the real-time interaction query module 31 transmits the mobile identifier to the mobile positioning system 4 through the positioning system interface sub-module 313 in the real-time interaction query module 31. In a step (C2), the mobile positioning system 4 interacts with the mobile terminal 1 according to this mobile identifier and through the mobile network system 2 to obtain the location of this mobile terminal 1. In a step (C3), the mobile positioning system 4 transmits the location to the request information processing sub-module 312 through the positioning system interface sub-module 313 in the real-time interaction query module 31.

Step (D) is implemented through the following steps. In a step (D1), the request information processing sub-module 312 in the real-time interaction query module 31 forwards location and related content of the request information to the processing system interface sub-module 314, and then transmits to the automatic information processing system 5. In a step (D2), the automatic information processing system 5 generates location-based information according to the content of the request information and obtained location, and then transmits this information to the request information processing sub-module 312 through the processing system interface sub-module 314. In a step (D3), the request information processing sub-module 312 feeds back the location-based information to the mobile terminal 1 through the mobile network system 2.

In step (D2), the process of generating location-based information according to the content of the request information and obtained location includes the following steps. In a step (D21), a message processing module of the automatic information processing system 5 classifies the content of the request information, where there is an automatic reply type and an data extract type. If the content of the request information is the automatic reply type, a step (D22) is executed. If the content of the request information is the data extract type, a step (D23) is executed.

In step (D22), an automatic reply module extracts corresponding data according to content of the request information, generates reply content by integrating the extracted data with the location, and takes this reply content as the location-based information. The automatic reply type thereof is usually adopted in a request manner where the subscriber inputs the request content by the mobile terminal 1.

In step (D23), according to the content of the request information, a data extract module extracts corresponding information data from corresponding data storage position, generates reply content by integrating this information data with the location, and takes this information data as the location-based information. The automatic reply type is usually adopted in the request manner where the subscriber inputs request content by way of menu in the mobile terminal 1.

Therefore, in certain embodiments, the mobile identifier is a mobile telephone number and the instant messaging identifier is an instant messaging tool number. In other embodiments, other kinds of mobile identifiers and instant messaging identifiers can alternatively or also be adopted without affecting implementation of the disclosed method and system.

The foregoing description sets forth a number of embodiments of the disclosed method and system that are not used to confine the scope of the present invention, and various changes in form and details may be made without departing from the spirit and scope of the invention.

1. An information feedback method based on instant messaging, the information feedback method comprising the steps of:
(A) determining location of a mobile terminal according to an instant messaging identifier included in request information sent by the mobile terminal; and,
(B) generating location-based information and feeding back the generated information to the mobile terminal according to the determined location and contents of the request information.

2. The method according to claim 1, wherein step (A) comprises the steps of:
(A1) the mobile terminal sending a request with a corresponding instant messaging identifier of the mobile terminal to an instant messaging system;
(A2) according to the instant messaging identifier in the request information, the instant messaging system determining a corresponding mobile identifier of the instant messaging identifier, and sending the mobile identifier to the mobile positioning system; and,
(A3) the mobile positioning system determining location of the mobile terminal according to the received mobile identifier.

3. The method according to claim 2, wherein step (A2) comprises the steps of:
(A21) a real-time interaction query module of the instant messaging system sending a query request to a data module that stores corresponding relations between instant messaging identifiers and mobile identifiers, wherein the query request comprises the mobile identifier;
(A22) according to the instant messaging identifier included in the query request, the data module querying the corresponding mobile identifier of the instant messaging identifier and returning the mobile identifier and the query result to the real-time interaction query module; and,
(A23) the real-time interaction query module sending the mobile identifier to the mobile positioning system.

4. The method according to claim 1, wherein step (B) comprises the steps of:
(B1) the instant messaging system transmitting the contents of the request information and the location of the mobile terminal to an automatic information processing system;
(B2) according to the contents of the request information and the location, the automatic information processing system generating location-based information of the mobile terminal and returning the generated location-based information to the instant messaging system; and,
(B3) the instant messaging system transmitting the location-based information of the mobile terminal to the mobile terminal through a mobile network system.

5. The method according to claim 4, wherein step (B2) comprises the steps of:
(B21) a message processing module of the automatic information processing system classifies the contents of the request information, and if being an automatic reply type, executing step (B22), and if being a data extract type, executing step (B23);
(B22) an automatic reply module extracting corresponding data according to the contents of the request information and generating reply content by integrating the data with the location, and then returning the reply content that is taken as location-based information to the instant messaging system; and,
(B23) according to the contents of the request information, a data extract module extracting corresponding information data from corresponding data storage position and generating reply content by integrating the information data with the location, and then returning the reply content that is taken as the location-based information to the instant messaging system.

6. The method according to claim 2, wherein step (A1) comprises the mobile terminal interacting with the instant messaging system that stores the contents of the request information to obtain and select content of the request information, and then transmitting the content of the request information and the instant messaging identifier to the instant messaging system through the request information.

7. The method according to claim 2, wherein step (A1) comprises the mobile terminal determining content of the request information according to relevant content of the request information stored in the mobile terminal, and transmitting the content of the request information and the instant messaging identifier to the instant messaging system through the request information.

8. The method according to claim 7, further comprising the mobile terminal updating the relevant content of the request information stored in the mobile terminal by interacting with the instant messaging system.

9. An information feedback system based on instant messaging, comprising:
a mobile terminal, a mobile network system and a mobile positioning system, wherein the mobile positioning system interacts with the mobile terminal through the mobile network system and determines a location of the mobile terminal according to a mobile identifier of the mobile terminal, and wherein the information feedback system further comprises:
an instant messaging system that receives request information transmitted by the mobile terminal through the mobile network system, determines the corresponding mobile identifier according to an instant messaging identifier in the request information, obtains the location of the mobile terminal from the mobile positioning system with the mobile identifier, and then transmits the location to an automatic information processing system; and,
the automatic information processing system, which generates location-based information related with the mobile terminal according to the location and contents of the request information obtained from the instant messaging system, and which then feeds back the location-based information to the mobile terminal through the instant messaging system and the mobile network system.

10. The system according to claim 9, wherein the instant messaging system comprises:
a real-time interaction query module and a data module, wherein:
the real-time interaction query module receives the request information sent by the mobile terminal, obtains the mobile identifier by querying the data module according to the instant messaging identifier in the request information, obtains the location of the mobile terminal from the mobile positioning system by using the mobile identifier, obtains the location-based information from the automatic information processing system by using the location and the content of the request information, and then transmits the location-based information to the mobile terminal; and,
the data module stores corresponding relations between instant messaging identifiers and mobile identifiers.

11. The system according to claim 10, wherein the real-time interaction query module comprises:
a request information processing sub-module that establishes an information interconnection with a positioning system interface sub-module, a processing system interface sub-module and an identifier information query sub-module;
the positioning system interface sub-module that provides communication between the request information processing sub-module and the mobile positioning system;
the processing system interface sub-module that provides communication between the request information processing sub-module and the automatic information processing system; and,
the identifier information query sub-module that obtains request information from the request information processing sub-module according to the instant messaging identifier included in the request information from the request information, sends a query request to the data module for querying the mobile identifier, and transmits an obtained query result from the data module and the mobile identifier to the request information processing sub-module.

12. The system according to claim 11, wherein the real-time interaction query module further comprises an information content data sub-module that stores the content of the request information and a related menu item command and catalog, and provides the content of the request information for the mobile terminal by interacting with the mobile terminal.
